(19) United States
(12) Patent Application Publication
(10) Pub. No.: US 2007/0263780 A1
(43) Pub. Date: Nov. 15, 2007

(54) Emergency-response information system and method thereof

(76) Inventor: Michael Lentini, Reno, NV (US)

Correspondence Address: Michael Lentini, 1805 DAKOTA RIDGE TRAIL, Reno, NV, 89523, US

(21) Appl. No.: 11/397,590

(22) Filed: Apr. 3, 2006

(51) Int. Cl. H04M 11/04

(52) U.S. Cl. 379/37

(57) ABSTRACT

Disclosed is an emergency-response information system for providing emergency-response information for an individual in a fast, easy, inexpensive, and reliable manner that is readily accessible to a first responder, and the individual's friends, and family members. The emergency-response information system comprises a user computer accessible by a first responder; a web server providing an access code to be carried by the subscriber, the web server storing emergency-response information of a subscriber; and a network coupling the user computer to the web server, such that, the first responder accesses the web server using the user computer. The web server is capable of transmitting the emergency-response information to the user computer upon authentication of the access code inputted by the first responder through the user computer. By retrieving the emergency-response information instantaneously, the first responder may use the emergency-response information to save the individual in crisis, without wasting precious time.

### FIELD OF THE INVENTION

The present invention relates generally to information systems, and more particularly, to emergency-response information system, and method thereof.

### BACKGROUND OF THE INVENTION

In today's world, most people, especially students, business travelers, often live away from their family members. People often travel and spend days or weeks at a time living in places where nobody knows them and, if discovered sick, or hurt, strangers would have no idea how to contact their family members. In a scenario, where an individual is seriously injured to the extent that one is unable to speak, they could suffer long term damage because the doctor would not have an idea about the medical history or other relevant information for medical treatment of the injured individual. In another scenario, where a individual only has a limited time to live, family members need to be notified immediately so that the family members can make immediate plans to travel to the injured individual. Therefore, retrieving instant information in an emergency is critical for the individuals involved to take appropriate action as soon as possible. Also, in case of business travelers, it is very difficult to keep friends, and family members informed of their current location since the business travelers very often change their travel itinerary.

Several attempts have been made in the past to provide emergency-response information. For example, US Publication No. 20020059246 discloses a method for collecting emergency information from users. The emergency information is collected from the users and stored in a central storage server. Also the emergency information is stored on substation computers located in police stations, fire stations, hospitals, and other places where the emergency information may be useful. In an emergency, the emergency personnel can retrieve the information using the substation computers for use during the emergency. One problem identified with the above method is that the emergency information can be accessed in only those locations, where the emergency information is stored. This may not be ideal, since any individual apart from emergency personnel would want to retrieve instant emergency-response information. The disclosed method also fails to provide any means for instant notification of an emergency situation, or means for providing an individual's updated travel itineraries to friends, and families.

US Publication No. 20050128091 discloses a method and an apparatus for providing readily available information to emergency personnel. The disclosed apparatus is a keychain size USB flash memory device having a memory device and a connector. When the memory device carried by a person is plugged into a host computer, emergency personnel can readily view all the information relating to person's specific medical needs. In an emergency situation, the memory device may not be reliable, since the memory device itself is susceptible to physical damage, thereby destroying the information contained in it.

U.S. Pat. No. 6,155,409 discloses a personal emergency information and medication holder. The disclosed medication holder appears like a locket or pocket watch and can be worn on the person. The holder contains emergency quantity of medication to be taken if necessary. The holder also contains a universal product code, or other scannable code, which can be scanned by medical, or emergency personnel in the event of a crisis. The prior art does disclose availability of only medical information of a person to first responder, however does not discuss any means for instantaneously notifying an emergency situation to an individual's close friends and families. The prior also fails to disclose any means for providing an individual's updated travel itinerary to friends, and families.

Accordingly, what is needed is an emergency-response information system for providing emergency-response information of an individual in a fast, easy, inexpensive, and reliable manner that may be readily accessible to a first responder, and the individual's friends, and family members.

### SUMMARY OF THE INVENTION

In view of the foregoing disadvantages inherent in the prior art, the general purpose of the present invention is to provide an emergency-response information system, and method thereof, to include all the advantages of the prior art, and to overcome the drawbacks inherent therein.

In one aspect, the present invention provides an emergency-response information system, comprising: a user computer accessible by a first responder; a web server providing an access code to be carried by the subscriber, the web server storing emergency-response information of a subscriber; and a network coupling the user computer to the web server, such that, the first responder accesses the web server using the user computer; wherein the web server is capable of transmitting the emergency-response information to the user computer upon authentication of the access code inputted by the first responder through the user computer.

In another aspect, the present invention provides a method for providing emergency-response information, comprising: providing an access code to be carried by a subscriber; receiving the emergency-response information from the subscriber; storing the emergency-response information; and transmitting the emergency-response information to a first responder, upon authentication of the access code of the subscriber provided by the first responder.

In yet another aspect, the present provides a method, comprising: providing an access code to be carried by a subscriber; receiving emergency-response information from the subscriber; storing the emergency-response information; transmitting the emergency-response information to a first responder, upon authentication of the access code of the subscriber provided by the first responder; receiving travel itinerary information from the subscriber; storing the travel itinerary information; transmitting the travel itinerary information to a third party, upon authentication of the access code of the subscriber provided by the third party; receiving an emergency information from the first responder; storing the emergency information; and automatically notifying everyone on a contact list of the subscriber, in response to the first responder triggering an emergency alert.

These together with other aspects of the present invention, along with the various features of novelty that characterize the invention, are pointed out with particularity in the claims annexed hereto and forming a part of this disclosure. For a better understanding of the present invention, its operating advantages, and the specific objects attained by its uses, reference should be made to the accompanying drawings and descriptive matter in which, there are illustrated exemplary embodiments of the present invention.

### BRIEF DESCRIPTION OF THE DRAWINGS

The advantages and features of the present invention will become better understood with reference to the following more detailed description and claims taken in conjunction with the accompanying drawings, wherein:

FIG. 1 is a block diagram illustrating the network architecture of a emergency-response information system 100, according to an exemplary embodiment of the present invention;

FIG. 2 is a block diagram illustrating the functional components of a user computer 120, according to an exemplary embodiment of the present invention;

FIG. 3 is a block diagram illustrating different layers of a web page 160 associated with a web server 130, according to an embodiment of the present invention;

FIG. 4 is a process flow diagram illustrating a method of subscribing to the web server 130, and uploading emergency-response information onto the web server 130, according to an exemplary embodiment of the present invention;

FIG. 5A illustrates a bracelet 510 used as a means by a subscriber 121 to carry an access code provided by the web server 130;

FIG. 5B illustrates a dog tag 520 used as a means by a subscriber 121 to carry an access code provided by the web server 130;

FIG. 5C illustrates a subscriber card 530 used as a means by a subscriber 121 to carry an access code provided by the web server 130;

FIG. 6 is a process flow diagram illustrating retrieval of emergency-response information of a subscriber in an emergency situation by a first responder; and

FIG. 7 is a process flow diagram illustrating updating of travel itinerary information of a subscriber 121 via an email.

Like reference numerals refer to like parts throughout several views of the drawings of the present invention.

### DETAILED DESCRIPTION OF THE INVENTION

The exemplary embodiments described herein detail for illustrative purposes are subject to many variations. It should be emphasized, however, that the present invention is not limited to a particular emergency-response information system and method thereof, as shown and described. It is understood that various omissions, substitutions of equivalents are contemplated as circumstances may suggest or render expedient, but is intended to cover the application or implementation without departing from the spirit or scope of the claims of the present invention. Also, it is to be understood that the phraseology and terminology used herein is for the purpose of description and should not be regarded as limiting.

The use of “including,” “comprising,” or “having” and variations thereof, herein, is meant to encompass the items listed thereafter and equivalents thereof as well as additional items. As used herein, the terms “a” and “an” do not denote a limitation of quantity, but rather denote the presence of at least one of the referenced item.

The present invention provides an emergency-response information system, and method for providing emergency-response information. The present invention would aid a first responder in an emergency situation to have a direct access to an individual's (an individual seriously injured enough to be in an unconscious state or in a similar state) insurance information, blood type, medicinal allergies, current doctor information, and various other information for responding to an emergency situation. By retrieving the emergency-response information instantaneously, the first responder may use the emergency-response information to save the individual in crisis, without wasting precious time when trying to collect critical information from elsewhere. Another advantage of the present invention is that, the first responder can contact the individual's family members, relatives, friends and inform them of the emergency situation, using the contact information provided by the emergency-response information system. Also, the emergency-response information system may be used to instantaneously notify the emergency situation and the associated information to everyone on the individual's (herein after interchangeably referred to as subscriber, i.e., an individual who has subscribed to the emergency-response information system) contact list.

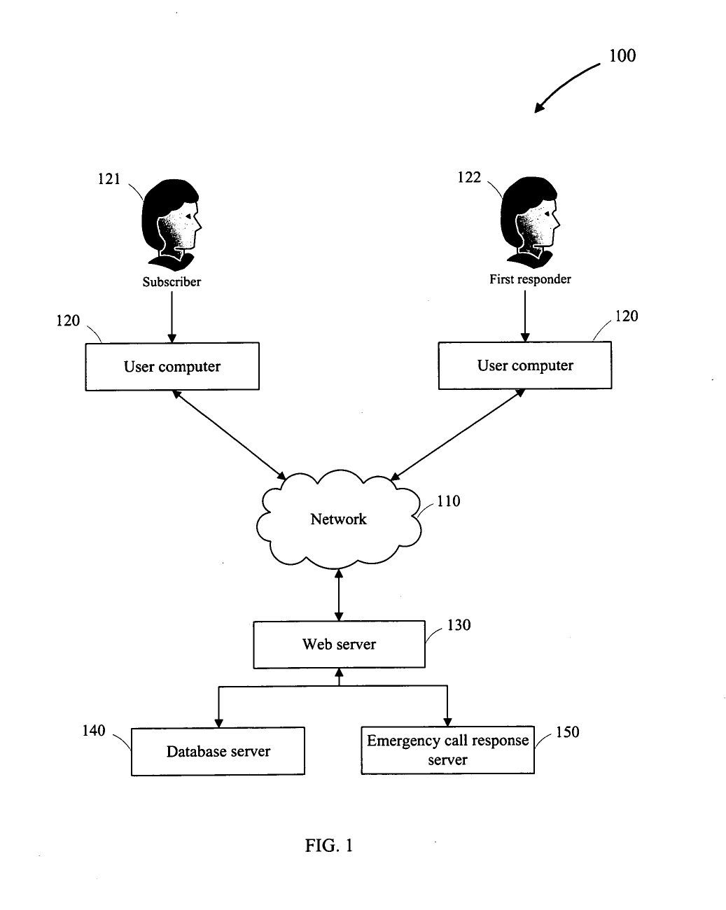

FIG. 1 illustrates network architecture of an emergency-response information system 100. The emergency-response information system 100 comprises a network 110, at least one user computer 120, and at least one web server 130. The user computer 120 may be used to access the web server 130 through the network 110. A subscriber 121, a first responder 122, or others, may access internet, for example, World Wide Web via the network 110 by providing Uniform Resource Locator (URL) or IP address from the user computer 120. The subscriber 121 may be a student, or a business traveler, or any other individual who lives away from other family members, such that, the subscriber 121 may provide instant emergency-response information to any first responder 122. The user computer 120 may include devices, such as, personal computers, workstations, laptops, personal digital assistants (PDA's), mobile phones, handheld devices, and the like.

The network 110 may include, but is not limited to, a local area network (LAN), wide area network (WAN), metropolitan area network (MAN), or a combination of similar or dissimilar networks. Also, the term ‘network’ refers to a plurality of networked computers, including the internet. The user computer 120 may be connected to the network 110 via wired, wireless, or optical connections.

The emergency-response information system 100 further comprises at least one database server 140, and at least one emergency call response server 150. The database server 140 is capable of storing emergency-response information, and other relevant information about the subscriber 121. The database server 140 may include data storage media, such as, magnetic media (tape drive, floppy disk), optical media (CDROM, hard disk), RAM, ROM, or the like. The database server 140 may communicate with the web server 130 through the network 110. The web server 130 may contact the emergency call response server 150 to make necessary automatic emergency phone calls. Optionally, the database server 140, and the emergency call response server 150 may reside in the web server 130.

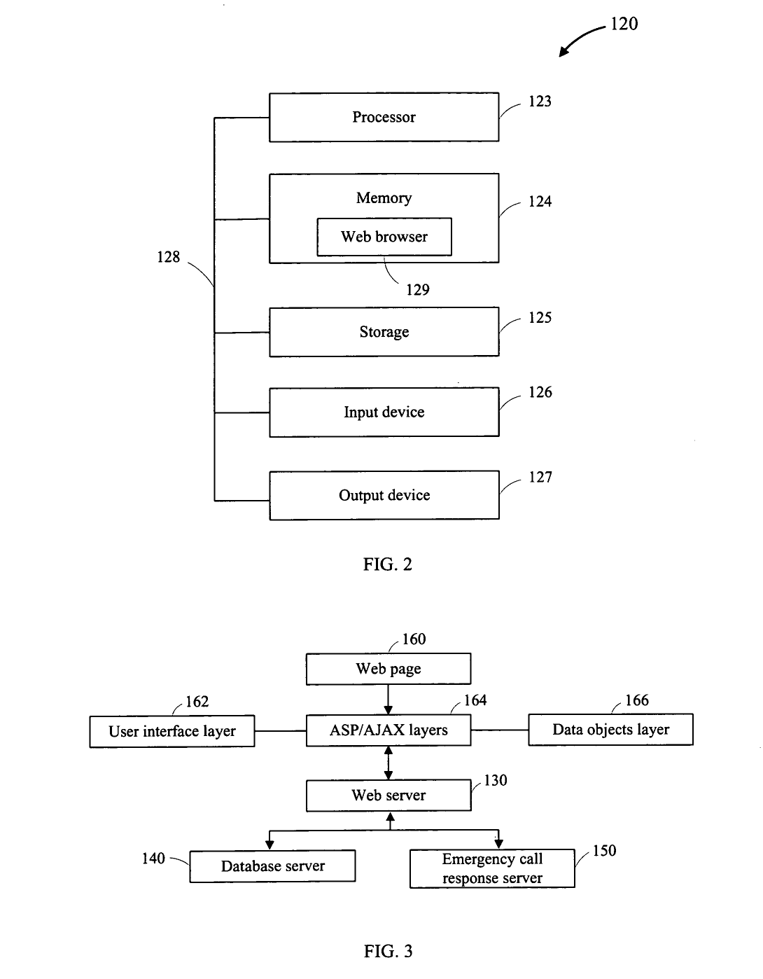

Referring to FIG. 2, a block diagram illustrating functional components of the user computer 120, is shown. The user computer 120 may include a processor 123, a memory 124, a storage 125, an input device 126, an output device 127, and, a bus 128. The processor 123 may be a conventional microprocessor capable of executing programmable instructions. The processor 123 is connected via the bus 128 to the memory 124, the storage 125, the input device 126 and the output device 127. The memory 124 is preferably a random access memory or any other type of dynamic storage device, sufficient to store the necessary programming instructions and data structures located on the user computer 120. The memory 124 may comprise an application program, for example, a web browser 129. The web browser 129 provides support for navigation among different web servers 130 and the web browser 129 is capable of locating network addresses of at least one web server 130. The user may log onto the internet through the web server 130 using the web browser 129. The web browser 129 displays text and/or graphic information on web pages. Also, some of the web pages may contain links to another document of the same web page or a different web page. The storage 125 may include a fixed and/or removable storage, such as, tape drives, floppy discs, removable memory cards, optical storage, and the like. The input device 126 may include, but is not limited to, keyboard, mouse, joystick, touchpad, scroll wheel, light pen, and touch screen. The output device 127 may include at least one conventional mechanism for outputting information to a display, a printer, and/or a speaker. The bus 128 may be any of several types of bus structures including a memory bus or a memory controller, a peripheral bus, and a local bus using any of a variety of bus architectures. In alternate embodiments of the present invention, additional peripheral components may be incorporated into the user computer 120.

Now Referring to FIG. 3, the web server 130 is capable of delivering a web page 160 (for example http://www.mycyber911.info) to the user computer 120 (FIGS. 1 and 2). The web server 130 may be implemented by any quantity of computer systems, end user or third-party computer system, or any combinations of these computer systems. The web page 160 may be formatted using hypertext markup language (HTML) and may be transferred through a communication protocol, such as, hypertext transfer protocol (HTTP). The web page 160 may comprise a user interface layer 162, ASP/AJAX layers 164, and a data objects layer 166. The user interface layer 162 provides GUI (Graphical User Interface) for the user to interact with the web server 130. The ASP/AJAX layer 164 provides improvement in the interactivity, speed, and usability for the user of the web server 130. The data objects layer 166 comprises object definitions that provide a logical representation of physical database residing in the database server 140. The web server 130 interacts with the database server 140 to access, and store the emergency-response information.

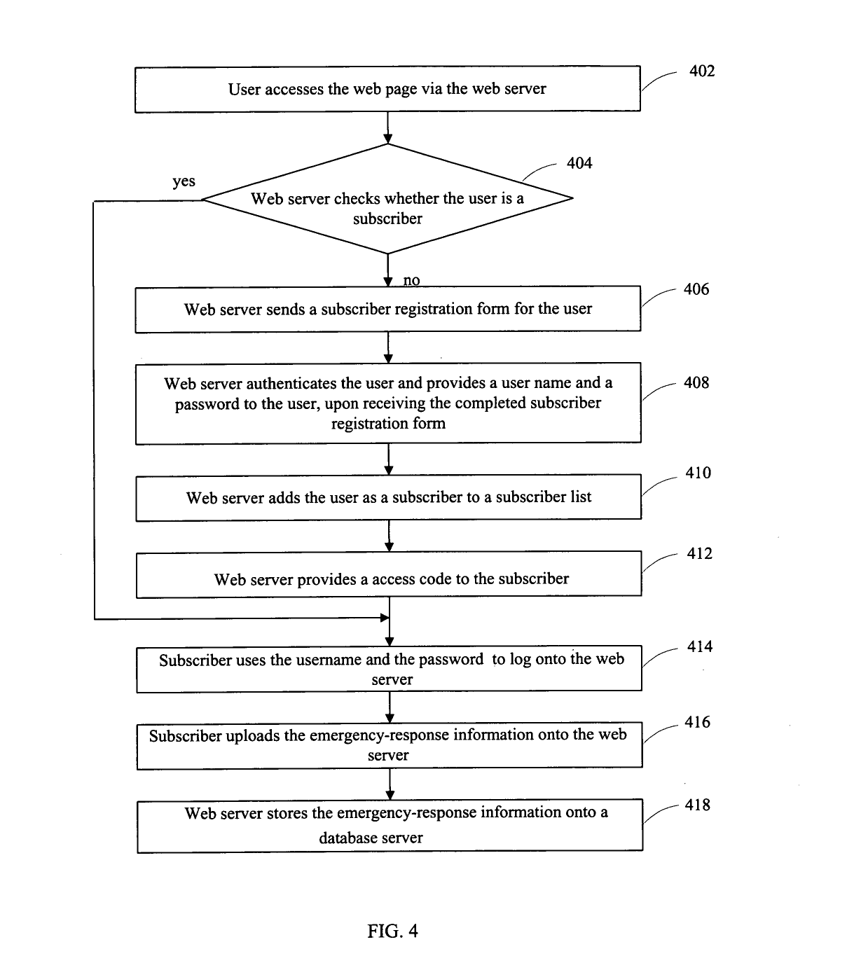

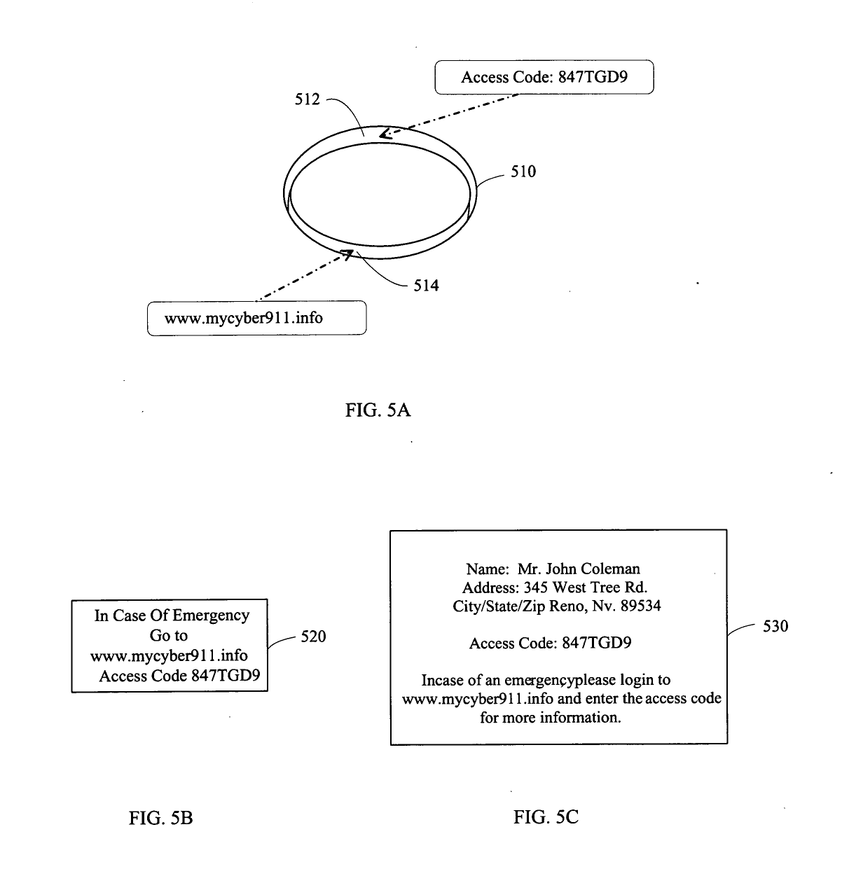

FIG. 4 is a process flow diagram illustrating a method of subscribing to the web server 130, and uploading emergency-response information onto the web server 130. A user inputs a predetermined URL in the web browser 129 of the user computer 120 to access the web page 160 via the web server 130 (Step 402). The web server 130 checks whether the user is already subscribed (Step 404). If the user has not been subscribed, the web server 130 sends a subscriber registration form for the user (Step 406). The subscriber registration form may include data fields, for example, user name, address, phone number, and the like. After the completed subscriber registration form is submitted to the web server 130 by the user, the web server 130 authenticates the user; and provides a user name and a password to the user (Step 408). The web server 130 then adds the user as a subscriber 121 to a subscriber list comprising a list of subscribers (Step 410). The web server 130 then provides an access code, which is unique for the subscriber 121 (Step 412). The access code may be carried by the subscriber 121 on a driver's license, or on a wrist band, or on an inside surface 512 of a bracelet 510; additionally, the URL of the web page 160 (for example, www.mycyber911.info) may be carried on an outside surface 514 of the bracelet 510 (See FIG. 5A), or a dog-tag 520 carrying the URL of the web page 160 alongwith the access code of the subscriber 121 (See FIG. 5B), or on a subscriber card 530 having a complete information of the subscriber, including, name, complete address, access code and the URL of the web page 160 (See FIG. 5C), or any other device suitable for carrying the access code. Optionally, the subscriber card 530 may have photo ID of the subscriber 121 along with subscriber's latest medical contact information. The subscriber 121 uses the user name and the password provided by the web server 130 to log onto the web page 160 (Step 414). The web server 130 may use a SQL server database to compare the user name with the password of the subscriber 121.

The subscriber 121 may then upload the emergency-response information onto the web server 130 (Step 416). The emergency-response information received by the web server 130 is then stored onto a subscriber database of the database server 140 (Step 418). The emergency-response information may include subscriber's name, subscriber's address, subscriber's contact information, subscriber's insurance information, subscriber's blood type, subscriber's medical allergies, subscriber's current doctor information, and other information that could save the life of the subscriber 121 in an emergency situation or a crisis. The emergency-response information may also include a contact list of the subscriber 121 comprising contact information (email, phone number, address) of the subscriber's friends, and relatives. Optionally, the subscriber 121 may also upload travel itinerary information onto the web server 130. The web server 130 may transmit the travel itinerary information to a third party, upon authentication of the access code of the subscriber 121 provided by the third party. The subscriber 121 may also edit or update the emergency-response information from time-to-time by logging onto the web page 160 using the access code.

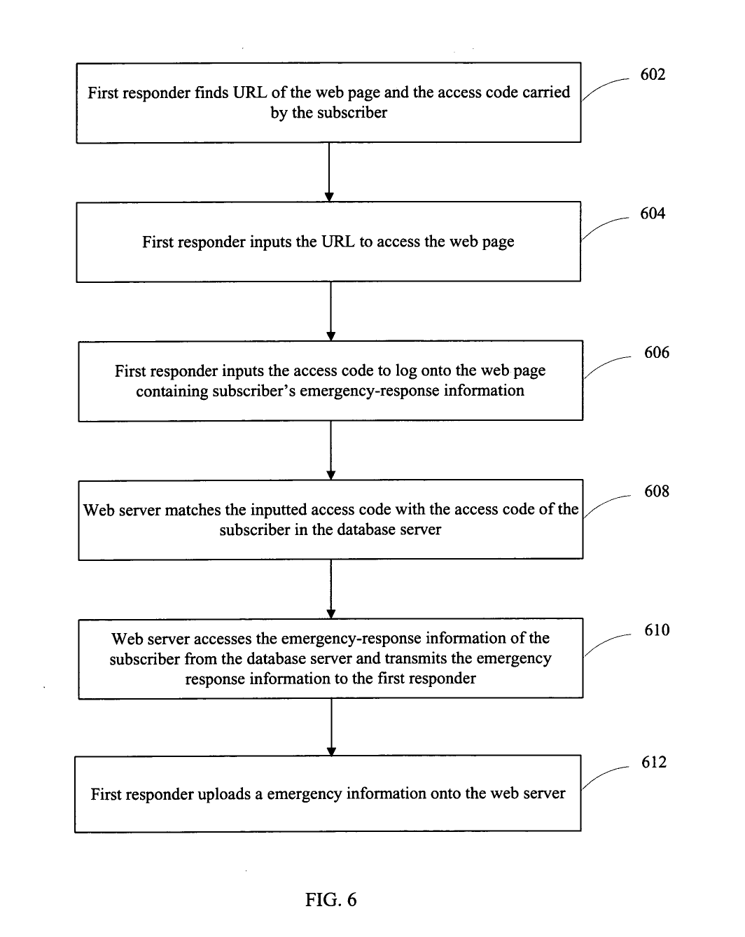

FIG. 6 is a process flow diagram illustrating retrieval of emergency-response information of the subscriber 121 in an emergency situation by the first responder 122. In response to an emergency situation, such as an accident, wherein the subscriber 121 is seriously injured, a person, i.e., the first responder 122 who responds to the emergency may find the URL of the web page 160 and the access code carried by the subscriber 121 (Step 602). The first responder 122 may access the user computer 120 and inputs the URL to access the web page 160 (Step 604). The first responder 122 then inputs the access code of the subscriber 121 on the web page 160 (Step 606). The web server 130 compares the inputted access code entered in the web page 160 and the access code of the subscriber 121 in the database server 140 (Step 608). If the access code inputted by the first responder 122 and the access code of the subscriber 121 present in the database server 140, matches, the web server 130 authenticates the first responder 122. The web server 130 then accesses the emergency-response information of the subscriber 121 from the database server 140 and transmits the emergency-response information to the first responder 122 (Step 610). The first responder 122 may then upload emergency information onto the web server 130 (Step 612). The web server 130 stores the emergency information onto the database server 140. The emergency information may include subscriber's medical condition including information, regarding the person treating the subscriber 121, current location of the subscriber 121, and the like. The web server 130 may transmit the emergency information to the third party upon authentication of the access code of the subscriber 121 provided by the third party. Optionally, the first responder's contact information may be uploaded by the first responder 122 onto the web server 130. Furthermore, in the event of the access code not matching with the access code in the subscriber list at the database server 140, the web server 130 informs the first responder 122 that no information was found.

In one embodiment, when the first responder 122 triggers an emergency alert on the web page 160, the emergency situation of the subscriber 121 is notified to everyone on the contact list of the subscriber 121 instantly, via emails, text messages, voice messages, emergency phone calls, and the like. Also, the web server 130 contacts the emergency call response server 150 to make necessary automatic emergency phone calls.

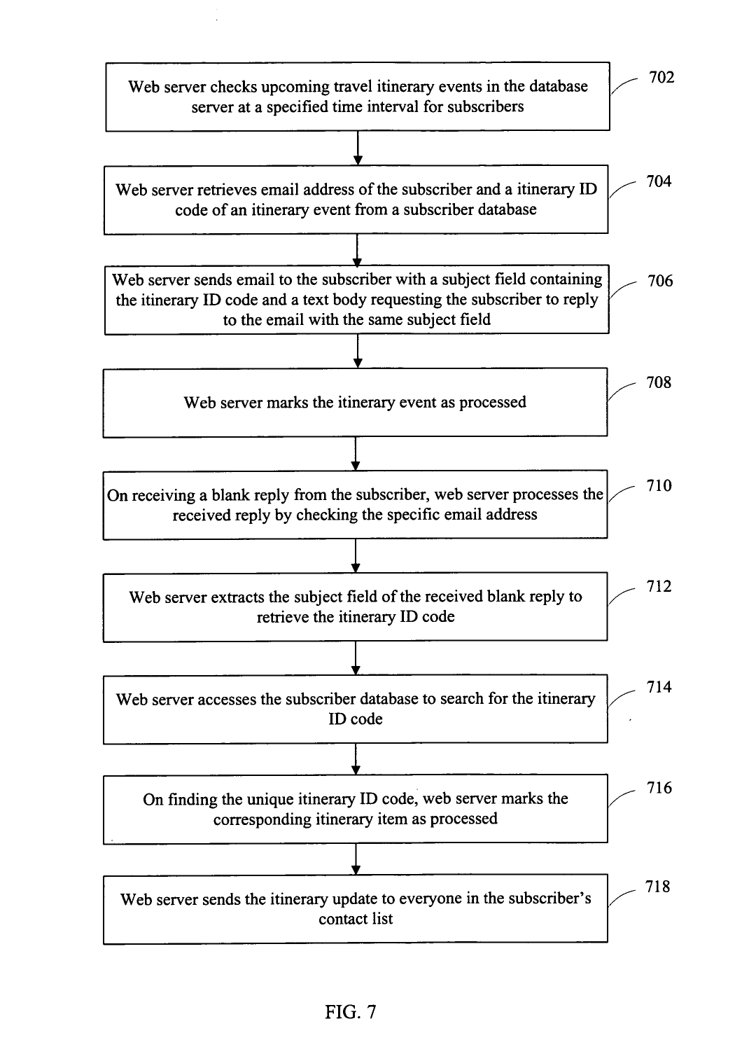

In an additional embodiment, the subscriber 121 may log on to the web page 160 using the username and password provided by the web server 130 to update an itinerary item of the travel itinerary information. FIG. 7 is a process flow diagram illustrating updating of travel itinerary information of the subscriber 121 via email. The web server 130 checks the upcoming travel itinerary events in the database server 140 at specified time intervals for subscribers 121 who have activated automatic email itinerary update feature of the web page 160 (Step 702). The web server 130 retrieves email address of the subscriber 121 and an itinerary ID code of an itinerary event (Step 704). The web server 130 then sends an email to the subscriber 121 with a subject field containing the itinerary ID code and a text body requesting the subscriber 121 to reply to the email with the same subject field upon completing the travel itinerary event (Step 706). Upon sending the email to the subscriber 121, the web server 130 marks the itinerary event as processed to avoid sending a duplicate email to the subscriber 121 (Step 708). In response to the email, the subscriber 121 may send a blank reply upon completing the travel itinerary event The web server 130 then processes the received blank reply by checking the specific email address (Step 710). The web server 130 then extracts the subject field of the received blank reply to retrieve the itinerary ID code (Step 712). The web server 130 then accesses the database server 140 to search for the itinerary ID code (Step 714). If the web server 130 finds the itinerary ID code, the corresponding itinerary item is marked as completed (Step 716). The web server 130 then queries the subscriber database of the database server 140 for the contact list of the subscriber 121 who wants to receive itinerary updates of the subscriber 121 and sends the itinerary update to everyone on the contact list of the subscriber 121 (Step 718).

Various embodiments may further include receiving, sending or storing instructions and or/data that implement the functionality of providing emergency-response information in accordance with the present invention, upon a computer readable medium. Such a computer readable medium may include but is not limited to a storage media or memory media such as magnetic media (e.g., floppy disks), optical media (e.g., disk or CD-ROM), volatile or non volatile media such as Random Access Memory (RAM), Read Only Memory (ROM), and the like, as well as transmission media or signals such as electrical, electromagnetic, or digital signals, conveyed via a communication means such as network and/or wireless link, wherein, when a computer program code, implementing the embodiments of the present invention, is loaded onto and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the invention to the precise forms disclosed, and obviously, many modifications and variations are possible in light of the above teaching. The embodiments were chosen and described in order to best explain the principles of the present invention and its practical applications, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. An emergency-response information system, comprising:
a user computer accessible by a first responder;
a web server providing an access code to be carried by a subscriber, the web server storing emergency-response information of the subscriber; and
a network coupling the user computer to the web server, such that, the first responder accesses the web server using the user computer;
wherein the web server is capable of transmitting the emergency-response information to the user computer upon authentication of the access code inputted by the first responder through the user computer.

2. The emergency-response information system of claim 1, wherein the web server is capable of providing a user name and a password to the subscriber in response to the subscriber registering on the web server.

3. The emergency-response information system of claim 2, wherein the web server is capable of establishing a session for receiving the emergency-response information of the subscriber upon authentication of the subscriber by verifying the username and the password.

4. The emergency-response information system of claim 1, wherein the emergency-response information is selected from the group consisting of subscriber's name, subscriber's address, subscriber's contact information, subscriber's insurance information, subscriber's blood type, subscriber's medical allergies, subscriber's current doctor information, and a combination comprising at least one of the foregoing.

5. The emergency-response information system of claim 1, wherein the web server is capable of storing the emergency-response information of the subscriber onto a database server.

6. The emergency-response information system of claim 1, further comprising an emergency call response server capable of automatically notifying everyone on a contact list of the subscriber, in response to the first responder triggering an emergency alert.

7. The emergency-response information system of claim 1, wherein the user computer is selected from the group consisting of personal computers, workstations, laptops, personal digital assistants, mobile phones, handheld devices, and a combination comprising at least one of the foregoing.

8. The emergency-response information system of claim 1, wherein the network is selected from the group consisting of local area networks, wide area networks, internet, intranet, and a combination comprising at least one of the foregoing.

9. The emergency-response information system of claim 1, wherein the access code is carried by the subscriber in a device selected from the group consisting of a wallet, a wrist band, a bracelet, a dog-tag, and a subscriber card.

10. A method for providing emergency-response information, comprising:
providing an access code to be carried by a subscriber;
receiving the emergency-response information from the subscriber;
storing the emergency-response information; and
transmitting the emergency-response information to a first responder, upon authentication of the access code of the subscriber provided by the first responder.

11. The method of claim 10, wherein the emergency-response information is selected from the group consisting of subscriber's name, subscriber's address, subscriber's contact information, subscriber's insurance information, subscriber's blood type, subscriber's medical allergies, subscriber's current doctor information, and a combination comprising at least one of the foregoing.

12. The method of claim 10, further comprising
receiving a travel itinerary information from the subscriber;
storing the travel itinerary information; and
transmitting the travel itinerary information to a third party, upon authentication of the access code of the subscriber provided by the third party.

13. The method of claim 12, further comprising:
automatically checking upcoming itinerary events of the travel itinerary information at a specified time interval for the subscriber;
retrieving an email address of the subscriber and an itinerary ID code from an itinerary event of the travel itinerary information from a subscriber database;
sending an email to the subscriber with a subject field containing the itinerary ID code and a text body requesting the subscriber to reply to the email upon completing the itinerary event;
marking the itinerary event as sent to the subscriber as processed;
extracting the subject field of a reply to retrieve the itinerary ID code, in response to the subscriber sending the reply to the email;
searching the subscriber database for the itinerary ID code;
marking the itinerary event as completed upon finding the itinerary ID code in the subscriber database; and
automatically notifying everyone on a contact list of the subscriber about the travel itinerary information of the subscriber via emails, text messages, voice messages, emergency phone calls, and a combination comprising at least one of the foregoing.

14 The method of claim 10, further comprising:
receiving emergency information from the first responder;
storing the emergency information; and
transmitting the emergency information to a third party, upon authentication of the access code of the subscriber provided by the third party.

15. The method of claim 14, wherein the emergency information is selected from the group consisting of the subscriber's medical condition, information about a person treating the subscriber, current location of the subscriber, and a combination comprising at least one of a foregoing.

16. The method of claim 10, further comprising automatically notifying everyone on a contact list of the subscriber, in response to the first responder triggering an emergency alert.

17. The method of claim 10, further comprising
receiving an updated emergency-response information from the subscriber; and
storing the updated emergency-response information.

18. A method, comprising
providing an access code to be carried by a subscriber;
receiving emergency-response information from the subscriber;
storing the emergency-response information;
transmitting the emergency-response information to a first responder, upon authentication of the access code of the subscriber provided by the first responder;
receiving travel itinerary information from the subscriber;
storing the travel itinerary information;
transmitting the travel itinerary information to a third party, upon authentication of the access code of the subscriber provided by the third party;
receiving emergency information from the first responder;
storing the emergency information; and
automatically notifying everyone on a contact list of the subscriber, in response to the first responder triggering an emergency alert.

19. The method of claim 18, wherein the emergency-response information is selected from the group consisting of subscriber's name, subscriber's address, subscriber's contact information, subscriber's insurance information, subscriber's blood type, subscriber's medical allergies, subscriber's current doctor information, and a combination comprising at least one of the foregoing.

20. The method of claim 18, wherein the emergency information is selected from the group consisting of the subscriber's medical condition, information about a person treating the subscriber, current location of the subscriber, and a combination comprising at least one of a foregoing.
